(19) United States
(12) Patent Application Publication
(10) Pub. No.: US 2022/0230164 A1
(43) Pub. Date: Jul. 21, 2022

(54) SYSTEMS AND METHODS FOR EFFECTIVELY ANONYMIZING CONSUMER TRANSACTION DATA

(71) Applicant: MasterCard International Incorporated, Purchase, NY (US)

(72) Inventors: Justin X. Howe, San Francisco, CA (US); Andrew Reiskind, Armonk, NY (US)

(21) Appl. No.: 17/703,518

(22) Filed: Mar. 24, 2022

Related U.S. Application Data
(63) Continuation of application No. 14/543,442, filed on Nov. 17, 2014, now abandoned.

(51) Int. Cl. G06Q 20/38; G06Q 30/06

(52) U.S. Cl. CPC G06Q 20/383; G06Q 30/0615

(57) ABSTRACT

Systems and methods are described for anonymizing personal information of consumers in a manner that protects against de-anonymization by a third party. In an embodiment, a system includes a data anonymizing subsystem and a payment transaction subsystem. A data preparation engine of the data anonymizing subsystem receives, from the payment transaction subsystem, consumer transaction data comprising personal information of a plurality of consumers and item identifiers, prepares the consumer transaction data and transmits the prepared consumer transaction data to an anonymization engine which receives and anonymizes the prepared consumer transaction data. In particular, the anonymization engine groups consumers associated with the prepared consumer transaction data into a plurality of consumer groups, quantifies a similarity between the plurality of consumer groups, combines the plurality of consumer groups, and discards all the consumer groups that contain less than a threshold number of consumers. A reporting engine then transmits the anonymized consumer transaction data to a third party device for consumer transaction analysis.

### CROSS-REFERENCE TO RELATED APPLICATION

This application claims the benefit of U.S. patent application Ser. No. 14/543,442 filed on Nov. 17, 2014, the contents of which are hereby incorporated by reference for all purposes.

### FIELD OF THE DISCLOSURE

Embodiments generally relate to systems and methods for effectively anonymizing consumer transaction data so that a third party cannot de-anonymize the consumer information to reveal personally identifiable information (PII) or non-public information (NPI) of the consumers. In some embodiments, consumer transaction data is anonymized on a stock keeping unit (SKU) level by grouping consumers with similar transaction data and then only providing the consumer transaction data of groups having a minimum group size, which may be dictated by privacy regulations, to a third party for analysis to prevent de-anonymizing of that consumer transaction data.

### BACKGROUND

Payment processors, networks and other entities create and process large amounts of consumer spending and payment-related data each day. The data is collected and stored to support transaction processing and for other purposes, such as ensuring that the parties involved in a transaction are properly compensated. The data has other potential uses as well, including for use to identify and/or analyze consumer spending patterns and behaviors. Thus, strict limitations and/or regulations have been applied to accessing and using such transaction data. For example, the United States enacted the Gramm-Leach-Bliley Act on Nov. 12, 1999, which addresses concerns relating to consumer financial privacy. In particular, provisions of the Gramm-Leach-Bliley Act limit when a financial institution may disclose a consumer's “nonpublic personal information” (sometimes referred to a “NPI”) to non-affiliated third parties. Accordingly, when a financial institution desires to transmit consumer transaction data to a non-affiliated third party, it is important that consumer transaction details be “de-identified” by removing any private or personally identifiable information (sometimes referred to as “PII”) of the consumers, or by “anonymizing” the consumer transaction data. Examples of a consumer's NPI and/or PII may include, but are not limited to, a name, address, telephone number, and numerous other personal facts such as homeownership status, income level, and birth date. Thus, de-identifying or anonymizing consumer PII before providing the consumer trnasaction data to a third party that wishes to identify and/or analyze consumer spending patterns, behaviors and/or tendencies, for example, is meant to protect the privacy of individual consumers.

Itemized purchase data is valuable for retailers and manufacturers, which is why many of them run loyalty programs. Unfortunately, much of this information cannot be shared (at least at a consumer level) because much of the consumer data can be de-anonymized. For example, in one famous instance, academics successfully de-anonymized a handful of Netflix profiles that were made public as part of a “Netflix challenge” by relying on groups of rare film information found in the data that are extremely uncommon. Since then, companies have shied away from sharing item level detail that is grouped at the customer level. But anonymized consumer data can also be advantageously used by marketers, retailers, and others to the benefit of themselves and consumers. For example, by knowing their customers' spending and buying habits, retailers can have adequate supplies on hand, gauge the proper prices for specific items, obtain more precisely tailored advertising, and determine the effectiveness of advertising and sales efforts. In addition, retailers may be able to better understand the lifestyle interests of consumers (for example, how many of their customers own cats and/or dogs, what hobbies are most prevalent in a particular group, and what types of magazines they read) and thus be able to, for example, make focused efforts via direct mail or e-mail communications, make smarter advertising decisions, and provide cross-promotions with other product or service providers.

It would be therefore be desirable to provide systems and methods for generating anonymized consumer transaction data for analysis by third party entities, wherein the anonymized consumer transaction data includes, for example, detailed item purchase histories per consumer (such as a payment card account holder), and wherein such anonymized transaction data cannot be de-anonymized or de-identified. Such anonymized consumer purchase transaction data can then be utilized by retailers, marketers or other third party organizations to conduct consumer profile analysis and/or determine business data, such as dynamic pricing data and the like. In particular, it would be desirable to provide anonymized SKU level purchase transaction data per consumer that cannot be de-anonymized or de-identified to determine personal consumer information.

### BRIEF DESCRIPTION OF THE DRAWINGS

Features and advantages of some embodiments, and the manner in which the same are accomplished, will become more readily apparent upon consideration of the following detailed description taken in conjunction with the accompanying drawings, which illustrate preferred and exemplary embodiments and which are not necessarily drawn to scale, wherein:

FIG. 1 is a block diagram illustrating a consumer payment transaction data anonymizing system according to some embodiments of the disclosure;

FIG. 2 illustrates a data preparation process in accordance with aspects of the novel anonymizing processes of the disclosure;

FIG. 3A is a flowchart illustrating an anonymization process in accordance with aspects of the novel processes of the disclosure;

FIG. 3B is a flowchart illustrating another anonymization process in accordance with novel processes of the disclosure;

FIG. 3C is a flowchart illustrating yet another anonymization process in accordance with novel processes of the disclosure; and

FIG. 4 illustrates an embodiment of a consumer data anonymization computer according to the disclosure.

### DETAILED DESCRIPTION

Embodiments generally relate to systems and methods to anonymize consumer transaction data in a manner to protect against de-anonymization to ensure the privacy and identity of individual consumers, and for providing third parties, such as marketers and/or retailers with the anonymized consumer transaction data for analysis. The types of information that the third party may be able to glean from the anonymized transaction data of groups and/or subgroups of consumers may include information about consumer lifestyles, buying habits, demographics, and the like. More particularly, embodiments relate to systems and methods that include preparing the consumer transaction data and then anonymizing the consumer transaction data using one or more anonymization methods, techniques or combinations thereof. The processes described herein provide anonymized consumer transaction data that cannot be de-anonymized, for example, by a third party cross-referencing the consumer transaction data to publicly available data in order to obtain personally identifiable information of one or more consumers. Thus, the anonymized consumer transaction data obtained according to the systems and processes described herein may be provided to third parties to conduct further consumer transaction analysis without fear of de-anonymization and thus without invading consumer privacy and/or without violating consumer privacy rules, regulations and/or laws.

A number of terms are used herein. For example, the term “anonymized data” or “de-identified data” are used to refer to data or data sets that have been processed or filtered to remove any personally identifiable information (PII) of consumers. In addition, the term “payment card network” or “payment network” as used herein refers to a payment network or payment system operated by a payment processing entity, such as MasterCard International Incorporated, or other networks which process payment transactions on behalf of a number of merchants, issuers and payment account holders (such as credit card account and/or debit card account and/or loyalty card account holders, commonly referred to as cardholders). Moreover, the terms “payment card network data” or “network transaction data” or “payment network transaction data” refer to transaction data associated with payment or purchase transactions that have been processed over a payment network. For example, network transaction data may include a number of data records associated with individual payment transactions (or purchase transactions) of consumers that have been processed over a payment card network. In some embodiments, network transaction data may include information that identifies a cardholder, a payment device or payment account, a transaction date and time, a transaction amount, items that have been purchased, and information identifying a merchant and/or a merchant category. Additional transaction details may also be available in some embodiments.

Examples of anonymization process embodiments are illustrated in the accompanying drawings, and it should be understood that the drawings and descriptions thereof are not intended to limit the invention to any particular embodiment(s). On the contrary, the descriptions provided herein are intended to cover alternatives, modifications, and equivalents thereof. Thus, although numerous specific details are set forth in order to provide a thorough understanding of the various embodiments, some or all of these embodiments may be practiced without some or all of the specific details. In other instances, well-known process operations have not been described in detail in order not to unnecessarily obscure novel aspects.

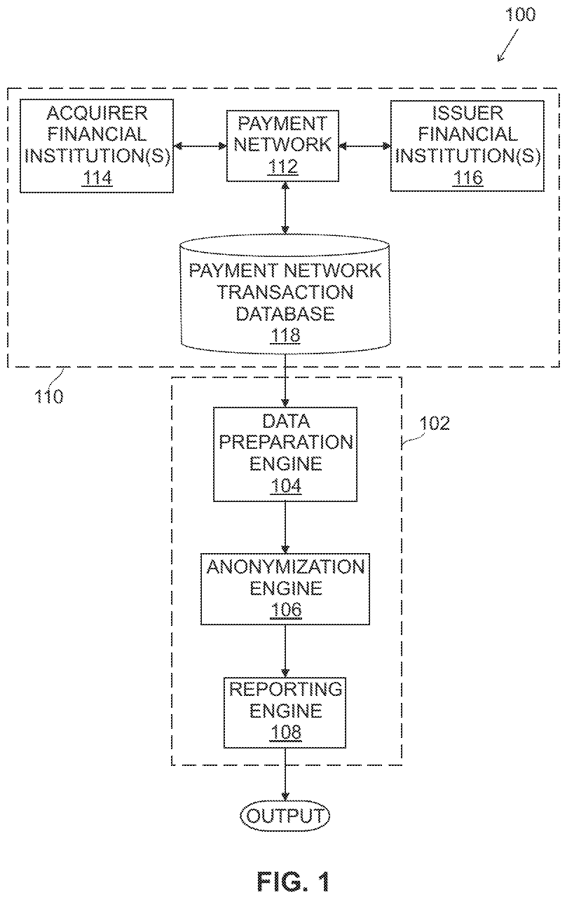

FIG. 1 is a block diagram illustrating a consumer payment transaction data anonymizing system 100 according to some embodiments. The various blocks or components shown in FIG. 1 may represent modules, computers and/or computer systems, and a number of entities and/or devices that interact to provide, for example, consumer purchase transaction data, updates, support messages, alerts and/or other messages and/or information and/or data. Furthermore, it should be understood that the various modules and/or computers and/or computer systems of FIG. 1 may be configured to communicate directly with one another via, for example, secure connections, or may be configured to communicate via the Internet and/or via other types of computer networks and/or communication systems in a wired or wireless manner. In addition, the modules and/or computers and/or computer systems may include one or more storage devices and/or databases, and such storage devices may be a non-transitory computer readable medium and/or any form of computer readable media capable of storing instructions and/or application programs and/or data for use by the modules and/or computers and/or computer systems. It should be understood that the non-transitory computer-readable media comprise all computer-readable media, with the sole exception being a transitory, propagating signal.

Referring again to FIG. 1, a data anonymizing subsystem 102, shown in dotted line, may include a data preparation engine 104 operably connected to an anonymization engine 106 which is operably connected to a reporting engine 108. Also depicted is a payment transaction subsystem 110 that includes a payment network 112 operably connected to a plurality of acquirer financial institutions (FIs) and a plurality of issuer FIs 116. The payment network 112 is also operably connected to a payment network transaction database 118 which stores consumer purchase transaction data. It should be understood that some or all of the components of the transaction anonymizing system 100 may be operated by or on behalf of an entity providing transaction analysis services. For example, in some embodiments, the data anonymizing subsystem 102, the payment network 112 and the payment network transaction database 118 may all be operated by or on behalf of a payment processor company or association (such as MasterCard International Incorporated, the assignee of the present application) as a service for third party entities such as merchants, merchant acquirer financial institutions (FIs), issuer FIs, marketers, and the like.

With regard to a payment transaction, a consumer typically enters a retail store and makes a purchase with his or her payment card, such as a credit, debit, convenience, or ATM card, at a merchant point-of-sale (POS) terminal or device (not shown). The POS device transmits purchase transaction data that includes the consumer's payment card account information (for example, the primary account number (PAN) and other data), the stock keeping unit (SKU) identifiers of merchandise and/or other item identifiers, the transaction amount, and/or a merchant identifier to an acquirer financial institution (FI), which transmits a transaction authorization request data to the payment network 112. The payment network 112 determines which financial institution issued that consumer's payment card account, generates a purchase transaction authorization request and transmits it to the issuer FI 116 that issued the consumer's payment card. If all is in order (for example, the issuer FI determines that the consumer's payment card account includes sufficient credit to cover the cost of the purchase transaction), the payment network 112 receives a purchase authorization response which is then transmitted to the merchant acquirer FI and forwarded to the POS device so that the consumer can take possession of the purchased item(s) or merchandise. The payment network 112 also collects the purchase transaction data including the authorization response, builds a transaction file that contains, for example, credit card or debit card information, card number, type(s) of item(s) purchased, transaction amount, and the date of the transaction, and stores the transaction file in the payment network transaction database 118.

In some embodiments, the data preparation engine 104 processes consumer transaction data stored in the transaction data files and then transmits it to the anonymization engine 106 for anonymizing processing. In some implementations, the data preparation engine 104 removes from the consumer transaction data purchased item data for items or products that have been for sale in the marketplace for less than a minimum predetermined period of time (for example, six months) to guarantee that such “new” or newly-introduced items or products will not be present and/or included in any of the resultant consumer profiles. Removal of such newly-introduced items helps to further anonymize a consumer's purchase transaction history. After the consumer transaction data is anonymized, it is then transmitted to the reporting engine 108 to output to, for example, a third party marketing company. According to processes described herein, the purchase transaction data is anonymized such that it cannot be de-anonymized or de-identified to protect the privacy of the consumers personal identity information (or non-public information) from the third party.

In the example system 100 shown in FIG. 1, the data anonymizing subsystem 102 is shown receiving data input from a payment transaction subsystem 110. It should be understood, however, that consumer transaction data could be provided by various different types of transaction systems or computerized data systems in various formats for anonymization in accordance with the systems and processes describe herein. Thus, in some embodiments, the data anonymizing subsystem 102 is configured to receive and anonymize consumer data from a plurality of different data sources including the payment transaction subsystem 110, and/or receive merchant transaction data (e.g., from purchase transactions conducted at one or more merchant retail locations and/or via a retail website and the like), and/or receive mobile network call data (e.g., from one or more mobile network operators (MNOs)), and/or receive public transit transaction data (e.g., from a metropolitan public transportation organization), and/or receive social media activity data (e.g., from social media organizations and/or websites such as Facebook™, Twitter™, LinkedIn™, Pinterest™, Google Plus+™, Tumblr™, Instagram™, and/or Flickr™), and/or receive data from other entities and/or websites associated with other activities and/or transactions (for example, consumer activity or consumer transaction data captured by one or more Smartphone applications). Thus, consumer activity data may include, but are not limited to, details concerning payment card transactions, SKU level transactions, transit transactions (for example, entering and/or exiting a subway station), wireless cell phone calls, text messages, twitter tweets, activity data regarding consumer location data generated from a mobile application leveraging a cell phone's GPS capability, consumer Foursquare check-ins, and any other consumer activity that may include transaction data and/or date, time and location data.

It should be understood that the various blocks or modules shown in FIG. 1 may represent any number of processors and/or modules and/or computers and/or computer systems configured for processing and/or communicating information via any type of communication network, and communications may be in a secured or unsecured manner. In some embodiments, however, the modules depicted in FIG. 1 are software modules operating on one or more computers. In some embodiments, control of the input, execution and outputs of some or all of the modules may be via a user interface module (not shown) which includes a thin client or thick client application in addition to, or instead of, a web browser.

As used herein, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network. In addition, entire modules, or portions thereof, may also be implemented in programmable hardware devices such as field programmable gate arrays, programmable array logic, programmable logic devices or the like or as hardwired integrated circuits.

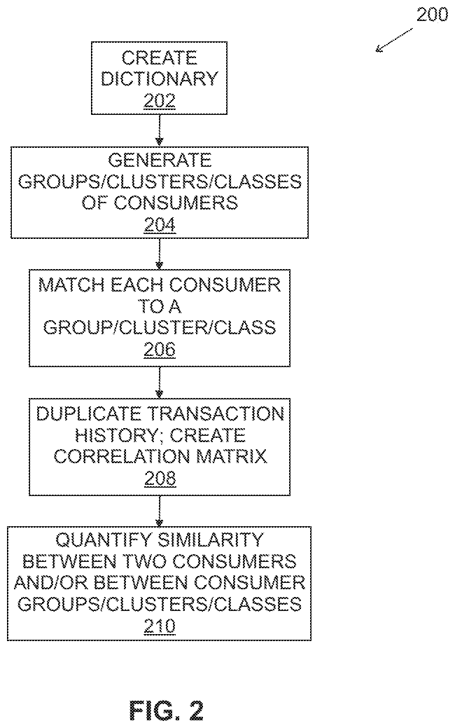

FIG. 2 illustrates a data preparation process 200 in accordance with aspects of the novel anonymizing processes disclosed herein. In an example, the data preparation engine 104 (see FIG. 1) receives purchase transaction data and then creates 202 a dictionary of all the purchase transaction data items along with each item's earliest purchase date and frequency of items purchased over all consumers. The data preparation engine then generates 204 groups and/or clusters and/or classes of consumers. For example, if the persons of interest are consumers who purchase consumer media entertainment, then those consumers may be grouped according to several categories such as the genre of entertainment (for example, comedy, drama, action, science fiction, and the like), frequency watched, the medium purchased (for example, DVDs, Bluray disks, VHS tapes, streaming movies or shows, and the like), and those consumer transactions that occur within a predetermined time frame (for example, the last quarter of the previous year, or the first half (6 months) of the current year).

Referring again to FIG. 2, each consumer is then matched 206 to a group and/or cluster and/or class, the transaction history of the consumers is duplicated 208 to create a “modifiable history” and a correlation matrix is created of all the products. The modifiable history can be adjusted and/or modified to prevent de-anonymization according to one or more of the anonymization processes described herein, whereas the unaltered consumer history of purchases for each consumer can be saved and/or stored intact. The correlation matrix may be used to determine if two or more different products are highly correlated, which means that they can be swapped for one another during an anonymization process. For example, if the correlation matrix indicates that seventy percent of the consumer population which viewed “The Matrix” also viewed “Top Gun,” then these two titles can be swapped from one consumer's purchase history to another consumer's purchase history to anonymize both of those consumers without adversely affecting the overall consumer purchase transaction data. In addition, for consumers that viewed both of these movie titles, one movie title can be removed to help anonymize the consumer transaction data of those consumers. In some implementations, a correlation value of less than 0.5 (or less than 50%) for an item prevents that item from being removed and/or swapped with another consumer's item(s). In some embodiments, separate and/or different matrices may be generated for different intervals of time. Next, the data preparation engine quantifies 210 the similarity between two consumers or between two consumer groups and/or clusters and/or classes. This can be calculated, for example, as a cosine similarity metric in a multivariate space.

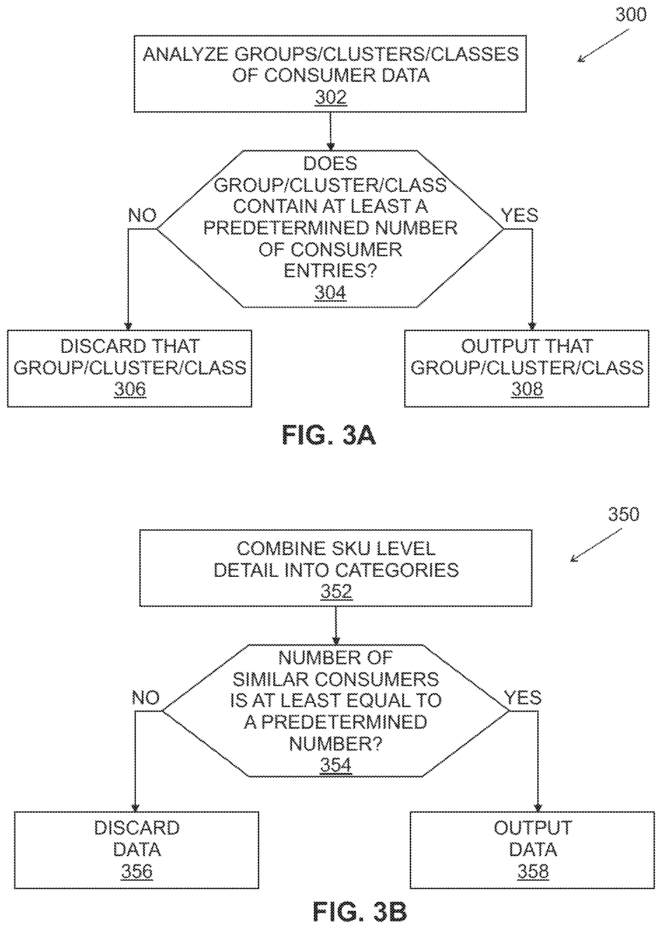

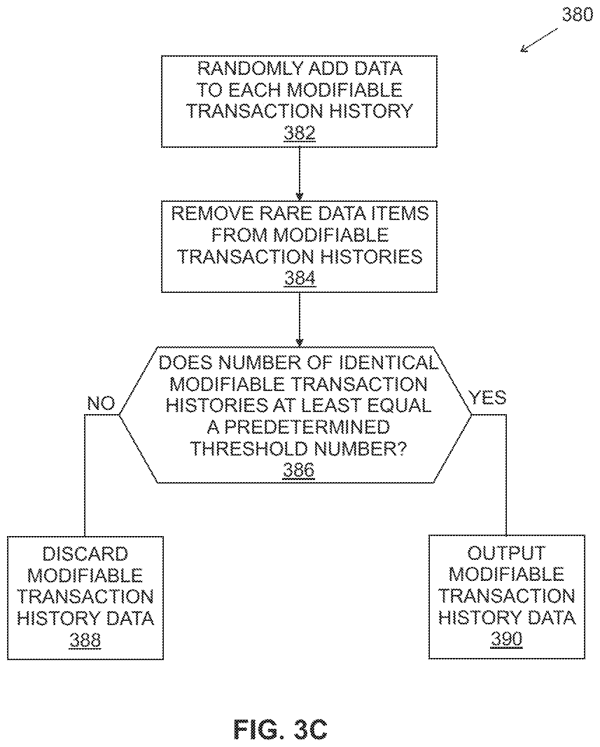

FIG. 3A is a flowchart illustrating an anonymization process 300 in accordance with aspects of the novel processes disclosed herein. The anonymization engine 106 of FIG. 1, for example, analyzes 302 the groups and/or clusters and/or classes of consumer data that is based on their SKU history, and then determines 304 if the groups and/or clusters and/or classes of consumer data contain at least a threshold number of consumers (for example, 1,000 people) which may be required by law or regulation. If not, then that particular group and/or cluster and/or class of consumer transaction data is discarded 306 and not used; but if a particular group and/or cluster and/or class of consumer data does equal or exceed the threshold number then that group or cluster or class of consumer data is output as anonymized consumer data. Such anonymized consumer data may then be used by a third party to perform consumer data analysis.

FIG. 3B is a flowchart illustrating another anonymization process 350 in accordance with aspects of the novel processes disclosed herein. The anonymization engine combines 352 SKU level detail data into categories (such as movie genres), and then determines 354 if the number of similar consumers is greater than or equal to a predetermined threshold number of consumers. For example, to reduce data granularity, consumer transaction data for consumers who watched “Old Boy,” “Braveheart,” and “Kill Bill” movies can be combined and the specific movie titles replaced by the identifier “three violent action movies.” It should be understood that, although a movie industry example has been described, the processes disclosed herein can be applied to many other different types of consumer industries and/or products such as the snack food industry, the automotive industry, the apparel industry, the furniture industry, and the like. Thus, if the number of consumers in a particular group of similar consumers (in the example, those who watched three violent action movies) is greater than the threshold number, then the number or data for that category is output 358. For example, the anonymization engine may output the counts of each genre purchased by consumers wherein the number of similar consumers (as judged by, for example, a multivariate distance metric) is more than a threshold number of consumers (i.e. 1,000 people). However, if the number of consumers of a particular group is less than the predetermined threshold number, then that consumer transaction data is discarded 356 and not used.

FIG. 3C is a flowchart illustrating yet another anonymization process 380 in accordance with aspects of the novel processes disclosed herein. The anonymization engine may randomly add items 382 to each modifiable history, based on the correlation matrix (or an association matrix) and/or based on the item prevalence as per the dictionary prepared as per the data preparation process 200 of FIG. 2. In some embodiments, the addition of an item may be proportional to the correlation matrix of products and the products that already exist in the profile. For example, fake SKU data or fake item identification data or fake viewership data can be added to a specific consumer's purchase history to obscure that consumer's data from being de-identified. In a particular example, if consumer A is the only person who purchased a “Peter Pan” movie, then fake purchases of “Peter Pan” can be inserted in ten or more of other consumer's purchase histories to help prevent consumer A's data from being de-anonymized. In addition, the anonymization engine removes 384 items that the dictionary indicates are rare from the modifiable history, for example, whenever the frequency of purchase of a particular item is less than a given threshold number. In the example described above, since only one copy of “Peter Pan” appears in the entire dataset, it could be removed from consumer A's purchase history to render consumer A's purchase history more anonymous. In some implementations, selection for removal may be proportional to the rarity of a movie title, for example, while selection for addition is not proportional to the rarity of the title. Thus, “noise” can be introduced into a particular consumer's transaction history by either adding random fictitious data or removing certain data from the particular consumer's transaction data in a manner that does not detrimentally affect or ruin the usefulness of the data set, and that prevents de-anonymization of the particular consumer's personal identity data. The threshold number associated with the frequency of purchase of a particular item may be set to a particular number depending on various criteria, such as the number of consumers in a particular group or other consideration(s).

Referring again to FIG. 3C, the anonymization engine then determines 386 if the number of identical modifiable consumer transaction histories of a group is greater or equal to a predetermined threshold number of consumers having the identical purchase history. If not, then the modifiable transaction history is discarded 388; but if the number of identical modifiable consumer transaction histories is greater than the predetermined threshold, then they are output for use by a third party entity.

With regard to the anonymization processes described above with regard to FIGS. 3A to 3C, various considerations may be weighed in order to determine which of the three anonymization techniques should be utilized for a particular set of data. For example, it may be advisable to cluster data around a particular data point, such as a shop-keeping unit (SKU) before aggregating if the goal is to obtain data concerning that SKU and if an insufficient population size exists to segment without clustering on that data point. However, if a large enough population exists then clustering around the data point may not be advisable since granularity of analysis may be lost. The sufficiency of the population size may depend on various factors, including whether or not the anonymized data is to be provided to a trusted partner or is to be published. Moreover, in some embodiments, a combination of any of the anonymization processes depicted in FIGS. 3A-3C can be utilized, to provide anonymized consumer transaction data output for further processing by a third party entity.

Thus, in accordance with the processes disclosed herein, anonymized consumer data may be provided to third party entities for analysis and preparation of a number of reports that can be generated without revealing any consumer PII.

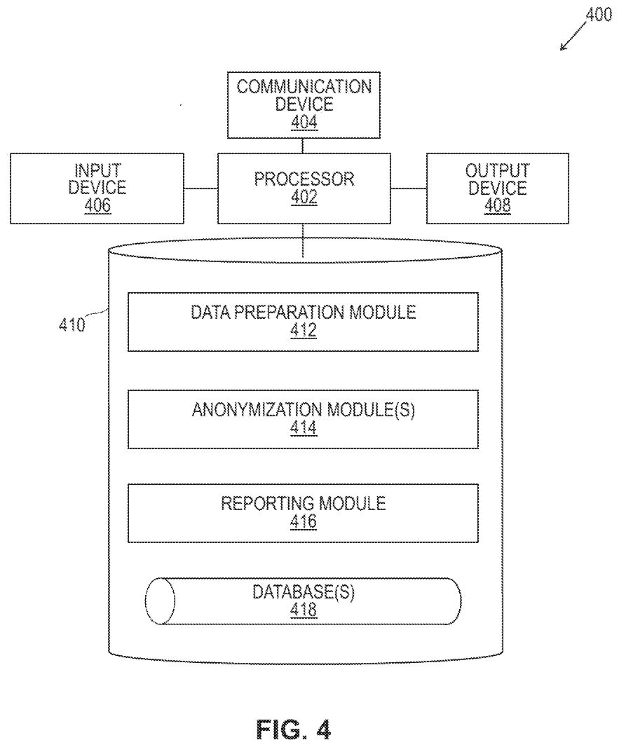

It should be noted that the embodiments described herein may be implemented using any number of different hardware configurations. For example, FIG. 4 illustrates an embodiment of a consumer data anonymization computer 400 that may, for example, be equivalent to the data anonymizing subsystem 102 of FIG. 1. The consumer data anonymization computer 400 comprises a processor 402, such as one or more commercially available Central Processing Units (CPUs) in the form of one-chip microprocessors, coupled to a communication device 404, which may be configured for communications with, for example, the payment network transaction database 118 shown in FIG. 1, and the like. The consumer data anonymization computer 400 further includes an input device 406 (for example, a computer mouse and/or keyboard that may be utilized to enter information such as business rules and/or logic) and an output device 408 (such as a computer monitor (which may be a touch screen) or printer to, for example, output reports and/or support user interfaces).

The processor 402 is also configured to communicate with a storage device 410. The storage device 410 may comprise any appropriate information storage device, including combinations of magnetic storage devices (e.g., a hard disk drive), optical storage devices, and/or semiconductor memory devices. The storage device 410 may therefore be any type of non-transitory computer readable medium and/or any form of computer readable media capable of storing computer instructions and/or application programs and/or data. It should be understood that non-transitory computer-readable media comprise all computer-readable media, with the sole exception being a transitory, propagating signal.

In some embodiments, the storage device 410 stores computer programs and/or applications and/or computer readable instructions operable to control the processor 402 to operate in accordance with any of the processes and/or embodiments described herein. For example, a data preparation module 412 may include instructions configured to cause the processor to prepare consumer transaction data from one or more consumer transaction data sources for anonymization processing. The storage device 410 may also store one or more anonymization modules 414 including instructions configured to cause the processor 402 to anonymize the prepared consumer transaction data in accordance with one or more of the processes described herein with regard to FIGS. 3A-3C. A reporting module 416 may also be stored by the storage device 410, and may include instructions configured to cause the processor 402 to output anonymized consumer transaction data for later analysis and/or processing by, for example, third parties such as merchants, marketers, financial institutions and the like. The modules 412, 414 and 416 may be comprised of computer instructions or code that may be stored in a compressed, uncompiled and/or encrypted format. The modules 412, 414 and 416 may furthermore include other program elements, such as an operating system, a database management system, and/or device drivers used by the processor 402 to interface with peripheral devices, such as the input devices 406 and/or output devices 408.

As used herein, information may be “received” by or “transmitted” to, for example, the consumer data anonymization computer 400 from/to another device. Also, information may be received or transmitted between a computer software application or module within the consumer data anonymization computer 400 and another software application, module, or any other source.

Referring again to FIG. 4, in some embodiments the storage device 410 further stores one or more databases 418. The database 418 may be configured for storing anonymized consumer transaction data that is grouped in various different ways, and which may be stored in various formats. It should be noted that the databases described herein are only examples, and are not intended to be limiting in any manner. Therefore, additional and/or different information may actually be stored therein than that described. Moreover, various databases might be split or combined in accordance with any of the embodiments described herein.

Pursuant to some embodiments, the operation of the consumer transaction data anonymization computer 400 and/or the consumer transaction data anonymization computer subsystem 102 may be based on several assumptions or rules to protect PII. Such assumptions or rules may include ensuring that any particular combined or matched consumer transaction data set (for example, a combined consumer transaction data set that includes consumer transaction data from a payment network, consumer transaction data from one or more merchants, and consumer transaction data from one or more social media operators) is anonymized before transmission or disclosure to a third party (who is the client requesting consumer transaction data for analysis).

It should be understood that the flow charts and descriptions thereof herein do not necessarily prescribe a fixed order of performing the method steps described. Rather, the method steps may be performed in any order that is practicable, including combining one or more steps into a combined step. In addition, in some implementations one or more method steps may be omitted.

Although embodiments disclosed herein have been described in connection with specific exemplary implementations, it should be understood that various changes, substitutions, and alterations apparent to those skilled in the art can be made without departing from the spirit and scope of the invention as set forth in the appended claims. Although a number of “assumptions” are provided herein, the assumptions are provided as illustrative but not limiting examples of one or more particular embodiments, and those skilled in the art appreciate that other embodiments may have different rules or assumptions.

What is claimed is:

1. A consumer payment transaction data anonymizing system for anonymizing personal information of consumers in a manner which protects against de-anonymization by a third party comprising:
a data anonymizing subsystem comprising:
a data preparation engine;
an anonymization engine operably connected to the data preparation engine;
a reporting engine operably connected to the anonymization engine; and
a payment transaction subsystem operably connected to the data anonymizing subsystem;
wherein the data preparation engine receives, from the payment transaction subsystem, consumer transaction data comprising personal information of a plurality of consumers and item identifiers, wherein each item identifier identifies an item having at least one attribute, and wherein the data preparation engine prepares the consumer transaction data and transmits the prepared consumer transaction data to the anonymization engine;
wherein the anonymization engine receives and anonymizes the prepared consumer transaction data by:
grouping consumers associated with the prepared consumer transaction data into a plurality of consumer groups based on item criteria;
quantifying a similarity between the plurality of consumer groups;
combining the plurality of consumer groups; and
discarding all the consumer groups that contain less than a threshold number of consumers resulting in anonymized consumer transaction data, wherein the anonymized consumer transaction data cannot be de-anonymized; and
wherein the anonymized consumer transaction data is transmitted by the reporting engine to a third party device for consumer transaction analysis.

2. The consumer payment transaction data anonymizing system of claim 1, wherein the payment transaction subsystem comprises:
a payment network;
a plurality of acquirer financial institution computers operably connected to the payment network;
a plurality of issuer financial institution computers operably connected to the payment network; and
a payment transaction database operably connected to the payment network.

3. The consumer payment transaction data anonymizing system of claim 1, wherein the at least one attribute comprises at least one of an earliest purchase date of an item and a frequency of purchase of the item.

4. The consumer payment transaction data anonymizing system of claim 1, wherein the item criteria for grouping consumers into a plurality of groups comprises first item criteria associated with a genre of entertainment and second item criteria associated with a frequency watched value.

5. The consumer payment transaction data anonymizing system of claim 4, wherein the item criteria further comprises a third criteria comprising a viewing medium.

6. The consumer payment transaction data anonymizing system of claim 1, wherein the consumer transaction data comprises at least one of unaltered consumer purchase history data and a stock keeping unit (SKU) associated with each purchased item.

7. A consumer payment transaction data anonymizing method for anonymizing personal information of consumers in a manner which protects against de-anonymization by a third party comprising:
receiving, by a data preparation engine of a data anonymizing subsystem from a payment transaction subsystem, consumer transaction data comprising personal information of a plurality of consumers and item identifiers, wherein each item identifier identifies an item having at least one attribute;
preparing, by the data preparation engine, the consumer transaction data;
transmitting, by the data preparation engine, the prepared consumer transaction data to an anonymization engine of the data anonymizing subsystem;
receiving, by the anonymization engine, the prepared consumer transaction data;
anonymizing, by the anonymization engine, the prepared consumer transaction data by:
grouping consumers associated with the prepared consumer transaction data into a plurality of consumer groups based on item criteria;
quantifying a similarity between the plurality of consumer groups;
combining the plurality of consumer groups; and
discarding all the consumer groups that contain less than a threshold number of consumers resulting in anonymized consumer transaction data, wherein the anonymized consumer transaction data cannot be de-anonymized; and
transmitting, by a reporting engine of the data anonymizing subsystem, the anonymized consumer transaction data to a third party device for consumer transaction analysis.

8. The method of claim 7, wherein the payment transaction subsystem comprises:
a payment network;
a plurality of acquirer financial institution computers operably connected to the payment network;
a plurality of issuer financial institution computers operably connected to the payment network; and
a payment transaction database operably connected to the payment network.

9. The method of claim 7, wherein the at least one attribute comprises at least one of an earliest purchase date of an item and a frequency of purchase of the item.

10. The method of claim 7, wherein the item criteria for grouping consumers into a plurality of groups comprises first item criteria associated with a genre of entertainment and second item criteria associated with a frequency watched value.

11. The method of claim 10, wherein the item criteria further comprises a third criteria comprising a viewing medium.

12. The method of claim 7, wherein the consumer transaction data comprises at least one of unaltered consumer purchase history data and a stock keeping unit (SKU) associated with each purchased item.
